(19) United States
(12) Patent Application Publication
(10) Pub. No.: US 2008/0122598 A1
(43) Pub. Date: May 29, 2008

(54) Device For Predictively Detecting And Avoiding Collisions

(75) Inventors: Jens Hamester, Leutenbach (DE); Michael Kokes, Schriesheim (DE); Bernd Oeffinger, Fellbach (DE); Sascha Paasche, Tokyo (JP); Andreas Schwarzhaupt, Landau (DE); Gernot Spiegelberg, Bad Abbach (DE); Wolfgang Stahl, Stuttgart-Untertuerkheim (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/662,708

(22) PCT Filed: Sep. 2, 2005
(86) PCT No.: PCT/EP05/09451

§ 371 Date: Dec. 4, 2007

(30) Foreign Application Priority Data
Sep. 15, 2004 (DE) 10 2004 044 517.6

(51) Int. Cl. B60R 16/023; B60R 16/03

(52) U.S. Cl. 340/435

(57) ABSTRACT

A device is provided for predictively detecting and avoiding motor vehicle collisions, including a control device, a sensor system for sensing obstacles in the surroundings of the vehicle, and a signal transmitter system for audibly and/or visually signaling a significant risk of collision between the vehicle and an obstacle. In order to increase the field of application of such a device, the vehicle can be a utility vehicle, the sensor system being divided into a front sensor arrangement which is arranged in the region of the front of a vehicle, and a rear sensor arrangement which is arranged in the region of the rear of a vehicle. The front sensor arrangement is connected to the control device via a data bus, while the rear sensor arrangement is connected to the control device via a power line communication.

### CROSS REFERENCE TO RELATED APPLICATIONS

This application is a national stage of PCT International Application No. PCT/EP2005/009451, filed Sep. 2, 2005, which claims priority under 35 U.S.C. § 119 to German Patent Application No. 10 2004 044 517.6 filed Sep. 15, 2004, the entire disclosures of which are herein expressly incorporated by reference.

### BACKGROUND AND SUMMARY OF THE INVENTION

The present invention relates to a device for predictively detecting and avoiding motor vehicle collisions.

Such a device is known from German patent document DE 101 03 767 A1 and includes a control device and a sensor system for sensing obstacles in the surroundings of the vehicle, and a signal transmitter system for audibly and/or visually signaling a significant risk of collision between the vehicle and an obstacle. It is significant here that, in the case of a risk of collision with the known device, the signal transmitter system outputs an audible warning signal to the outside in the direction of the obstacle. In this way, for example a motorcyclist who is approaching the vicinity of the vehicle without paying attention can be warned of an imminent risk of collision.

U.S. patent application publication US 2002/167398 A1 describes a utility vehicle with a semitrailer, data communication taking place via a power line communication system. Although application in detecting and avoiding collisions is mentioned, little is disclosed about the electronic architecture of the system.

International patent publication WO 03/028305 A describes a classic data bus system and the associated electronic architecture. Further information about data bus systems in means of transportation can be found in 22nd Convention of Electrical and Electronics Engineers in Israel. Proceedings 1 December 2002 in Tel-Aviv, page 306, ISBN: 0-7803-7693-5. In addition, Dohmke, Thomas: “Bus-systeme im Automobil [bus systems in automobiles]—CAN, FlexRay and MOST”, 2002, TÜ Berlin, XP002331425.

One object of the present invention is to provide an improved device for predictively detecting collisions for a utility vehicle, which device increases, in particular, the field of application of such a device in order to increase road safety.

This and other objects and advantages are achieved by the predictive detection device according to the invention, in which the sensor system is divided into a front sensor arrangement and a rear sensor arrangement. The front sensor arrangement is connected in the usual way to the control device via a data bus and, while the rear sensor arrangement is connected to the control device via a power line communication (PLC).

The design according to the invention makes it possible to arrange the front sensor arrangement and the control device near to one another in a front region of a utility vehicle, for example a truck, and to arrange the rear sensor arrangement at a distance therefrom in a rear region of the utility vehicle. The use of a PLC ensures reliable transmission of data between the rear sensor arrangement and the control device, even over the large distance between the rear of the vehicle and the front of the vehicle. In a PLC, instead of a signal line, a power supply line, which is present in the vehicle, is used to transmit data, the data signals being suitably modulated onto the power supply line. Therefore, particularly in utility vehicles, it is not necessary to lay additional, expensive signal lines.

Furthermore, the architecture according to the invention is also particularly suitable for retrofitting the respective utility vehicle, because there is no need to lay long signal lines in the rear of the vehicle in order to be able to integrate the rear sensor arrangement into the device.

The advantages of the design according to the invention become all the more clear in a development of the invention in which the utility vehicle is a vehicle combination composed of a towing vehicle and a trailer, if the rear of the vehicle is formed by the rear of the trailer. This means that the rear sensor arrangement is then arranged at the rear of the trailer and likewise communicates via PLC with the control device arranged in the cockpit of the towing vehicle.

Further important features and advantages of the invention emerge from the subclaims, from the drawings and from the associated description of the figures with reference to the drawings.

It goes without saying that the features which are specified above and which will also be explained below can be used not only in the respectively given combination but also in other combinations or alone without departing from the scope of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 to FIG. 3 show schematics of the device according to exemplary embodiments of the invention.

### DETAILED DESCRIPTION OF THE DRAWINGS

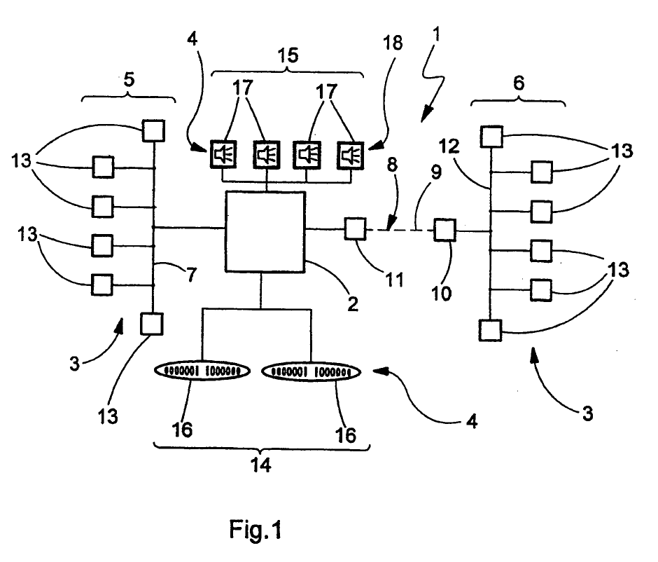

According to FIG. 1, a device 1 for predictively detecting and avoiding collisions for a utility vehicle (not otherwise illustrated) is equipped with a control device 2 which is connected to a sensor system 3 and a signal transmitter system 4. The device 1 can use the sensor system 3 to detect obstacles in the surroundings of the vehicle, to the outside toward the obstacle and/or to the inside toward the driver.

According to the invention, the sensor system 3 is divided into a front sensor arrangement 5 and a rear sensor arrangement 6. The front sensor arrangement 5 is arranged in a front region of the vehicle, while the rear sensor arrangement 6 is accomodated in a rear region of the vehicle. Since the control device 2 is also arranged in the front region of the vehicle, the front sensor arrangement 5 and the control device 2 are located relatively close to one another. In contrast to this, there is a relatively large distance between the control device 2 and the rear sensor arrangement 6. The front sensor arrangement 5 is connected to the control device 2 via a data bus 7. In contrast to this, the rear sensor arrangement 6 is connected to the control device 2 via a PLC 8. The PLC 8 uses a power supply line 9 of the vehicle, which leads from the front of the vehicle to the rear of the vehicle, for example, in order to supply a rear-end lighting device with electrical power. Accordingly, the device 1 according to the invention uses the power supply line 9 to transmit the signals generated by the rear sensor arrangement 6.

For this purpose, the PLC 8 is equipped with a rear transceiver 10 and with a control device transceiver 11. The rear transceiver 10 is assigned to the rear sensor arrangement 6 and serves to form a connection between the power supply line 9 and a data bus 12 of the rear sensor arrangement 6. That is to say, the rear sensor arrangement 6 is connected via the rear transceiver 10 to the power supply line 9. In contrast to this, the control device transceiver 11 serves to form a connection between the control device 2 and the power supply line 9, with the result that the control device 2 is connected via the control device transceiver 11 to the power supply line 9. The respective transceiver 10, 11 can modulate data signals onto the power supply line 9 and extract them therefrom. It is clear that “power supply line” can also be understood to mean a collection of a plurality of individual power supply lines, such as a multi-conductor line.

The sensor arrangements 5 and 6 are represented here symbolically as each being composed of a plurality of individual sensors 13. Each of the sensors 13 can be a distance sensor which operates on the basis of ultrasonic sound or infrared. Likewise, other sensors are conceivable, for example, those which operate with radar or with cameras and image processing programs. The number of sensors 13 is merely represented here by way of example with six per sensor arrangement 5, 6. Depending on the method of operation, a single sensor per sensor arrangement 5, 6 may also suffice.

The signal transmitter system 4 is divided here by way of example into a visual signal transmitter system 14 and an audible signal transmitter system 15. The visual signal transmitter system 14 may include, for example, two displays 16, one of which signals the front end distance of the vehicle from an obstacle, while the other signals the rear end distance of the vehicle from an obstacle. The design, arrangement and number of displays 16 is also represented here only by way of example.

The audible signal transmitter system 15 is equipped with a plurality of loudspeakers 17. By way of example, four loudspeakers 17 are illustrated here and they are expediently each arranged to the left and right at the front and the rear. It is clear that it is also possible for there to be more or fewer loudspeakers 17. The loudspeakers 17 form the loudspeaker arrangement 18, which can be configured as an external loudspeaker arrangement 18. That is to say, the loudspeakers 17 of the external loudspeaker arrangement 18 are distributed along an external circumference of the vehicle and can output the audible warning signals toward the outside.

In addition, or as an alternative, it is possible also for the loudspeaker arrangement 18 to be embodied as an internal loudspeaker arrangement 18 in which the loudspeakers 17 are distributed around the periphery of the cockpit of the utility vehicle. The loudspeakers 17 of the internal loudspeaker arrangement 18 can then output the warning signals in the direction of the driver in the interior of the cockpit.

According to one exemplary embodiment, the control device 2 can actuate the loudspeakers 17 of the external loudspeaker arrangement 18 selectively, such that an audible warning signal may be output toward the outside in the direction of the obstacle. For example, the loudspeaker 17 which is arranged at the front right of the vehicle will then be actuated to output the warning signal, if the obstacle is located near the front right of the vehicle.

In addition, or as an alterative, the control device 2 can actuate the loudspeakers 17 of the internal loudspeaker arrangement 18 selectively, such that the warning signal is output to the driver from the direction in which the obstacle is located relative to the vehicle. For example, the loudspeaker 17 which is arranged at the rear left in the cockpit is actuated to output the warning signal, if the obstacle is located near the rear left relative to the vehicle. As a result, the driver knows immediately where the obstacle is located relative to the vehicle. Furthermore, when detected obstacles are evaluated, the control device 2 can take into account the instantaneous direction of movement of the vehicle in order to compare the movement path of the vehicle with the location of the obstacle.

In addition, or as an alternative, the control device 2 can also be configured such that, in the case of a stationary vehicle, it takes into account a future direction of movement of the vehicle in the evaluation of the detected obstacles. For example, it is possible to take into account a steering wheel lock angle, a flashing indicator light which has been set and/or the position of a gear speed selector lever (forward gear speed or reverse gear speed) in order to determine the future direction of movement of the vehicle. For example, a motorcyclist is located to the right next to the vehicle at a traffic light. If the steering wheel lock points to the left or straight ahead, there is no risk of a collision with the cyclist. However, as soon as the driver steers to the right or sets the flashing indicator light to the right when the vehicle is stationary, this indicates the risk of a collision with the cyclist as soon as the traffic light turns green. The corresponding warning signal can prevent an accident here.

In another exemplary embodiment, the utility vehicle is a vehicle combination composed of a towing vehicle and a trailer. Depending on the type of vehicle combination, the trailer may be a semitrailer or a tow bar trailer, i.e., a trailer with a tow bar. However, the following description is directed to a trailer generally. With such a vehicle combination, the rear sensor arrangement 6 can then be arranged in the rear region of the trailer, since this region then forms the rear region of the entire vehicle, i.e., of the vehicle combination. The power supply line 9 of the PLC 8 is then a corresponding power supply line 9 which supplies the trailer with electrical power and which is connected to the on-board electrical system of the towing vehicle via a corresponding connection. The PLC 8 then also functions readily through such a connection.

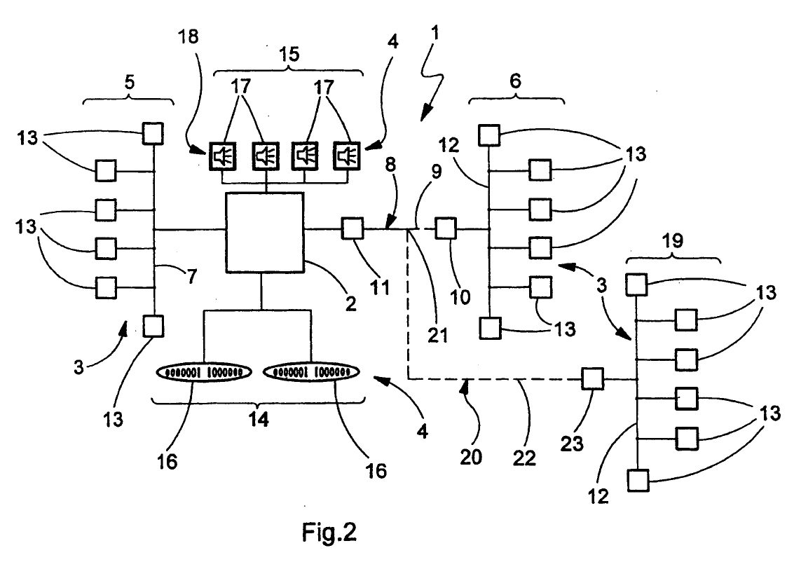

In an embodiment according to FIG. 2, the towing vehicle is equipped, (as in the embodiment according to FIG. 1) with a rear sensor arrangement 6, and the trailer is equipped with a separate trailer sensor arrangement 19 arranged at the rear. The rear sensor arrangement 6 is connected to the control device 2 via the PLC 8 which is laid in the towing vehicle and which is also referred to below as the towing vehicle PLC 8. Analogously, the trailer sensor arrangement 19 is connected via a trailer PLC 20 to the control device 2. Here, the trailer PLC 20 is connected to the towing vehicle PLC 8 at a connection point 21. Expediently, the connection point 21 corresponds to the location at which a trailer power supply line 22 is connected to the on-board power system of the towing vehicle, that is to say to the towing-vehicle power supply line 9.

In order to implement the trailer PLC 20, a trailer transceiver 23 is provided, via which the trailer sensor arrangement 19 is connected to the trailer power supply line 22. The trailer PLC 20 thus leads from the trailer transceiver 23 to the control device transceiver 11, as far as the towing vehicle, via the trailer power supply line 22, and via the towing-vehicle power supply line 9 inside the towing vehicle.

The towing vehicle PLC 8 or the control device transceiver 11 may be configured such that, when the trailer PLC 20 is connected, only the signals coming from the trailer sensor arrangement 19, instead of the signals of the rear sensor arrangement 6, are passed on to the control device 2. If the trailer PLC 20 is absent, the signals of the rear sensor arrangement 6 are then again passed on to the control device 2. As a result of this embodiment, when a trailer is hitched or unhitched, the device 1 is automatically adapted to the changed dimensions of the vehicle. In this way, the operational reliability of the vehicle can be considerably increased.

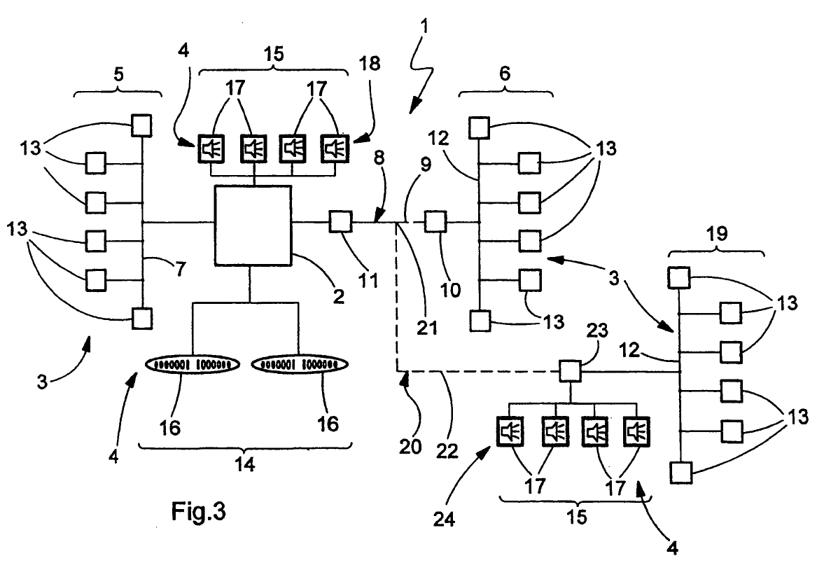

In one development of the device 1, the trailer can, according to FIG. 3, be additionally equipped with an external trailer loudspeaker arrangement 24 which generally forms a component of the audible signal transmitter system 15 or of the signal transmitter system 4. The loudspeakers 17 of the trailer loudspeaker system 24 are distributed along the circumference of the trailer. It is particularly advantageous here that the loudspeakers 17 of the trailer loudspeaker arrangement 24 are also connected to the trailer transceiver 23, and thus via the trailer PLC 20 to the control device 2. In this way, the trailer loudspeaker system 24 can be particularly easily integrated into the signal transmitter system 4 of the vehicle without corresponding control lines having to be laid for this purpose.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-11. (canceled)

12. A device for predictively detecting and avoiding motor vehicle collisions, comprising:
a control device;
a sensor system configured to sense obstacles in the surroundings of the vehicle;
a signal transmitter system configured to provide at least one of audible and visual signaling of a significant risk of collision between the vehicle and a first obstacle, wherein:
the vehicle is a utility vehicle,
the sensor system is divided into a front sensor arrangement which is arranged at the front of the vehicle, and a rear sensor arrangement which is arranged at the rear of the vehicle,
the front sensor arrangement is connected to the control device via a data bus,
the rear sensor arrangement is connected to the control device via a power line communication,
when detected obstacles are evaluated, the control device takes into account an instantaneous direction of movement of the vehicle, or if the vehicle is stationary, the control device takes into account a future direction of movement of the vehicle, to detect the significant risk of collision,
the control device determines the future direction of movement of the vehicle by evaluating at least one of a steering wheel lock angle, a flashing indicator light which has been set and a gear speed selector lever, and
the signaling takes place via the signal transmitter system.

13. The device as claimed in claim 12, wherein:
the utility vehicle is a vehicle combination including a towing vehicle and a trailer, and
the rear of the vehicle is formed by the rear of the trailer.

14. The device as claimed in claim 12, wherein:
the sensor system includes a trailer sensor arrangement which is arranged in the region of the rear of the trailer,
the rear sensor arrangement of the towing vehicle is connected to the control device via a towing vehicle power line communication,
the trailer sensor arrangement is connected to the control device via a trailer power line communication, and
the towing vehicle power line communication and trailer power line communication are connected such that, when the trailer power line communication is connected, the signals of the trailer sensor arrangement are passed on to the control device instead of the signals of the rear sensor arrangement.

15. The device as claimed in claim 14, wherein:
the trailer sensor arrangement is connected via a trailer transceiver to at least one trailer power supply line of the towing vehicle and via which the trailer power line communication is provided, and
the control device transceiver is configured such that when the trailer power line communication is connected, the control device transceiver passes on the signals of the trailer sensor arrangement, instead of the signals of the rear sensor arrangement, to the control device.

16. The device as claimed in claim 13, wherein:
the sensor system includes a trailer sensor arrangement which is arranged in the region of the rear of the trailer,
the rear sensor arrangement of the towing vehicle is connected to the control device via a towing vehicle power line communication,
the trailer sensor arrangement is connected to the control device via a trailer power line communication, and
the towing vehicle power line communication and trailer power line communication are connected such that, when the trailer power line communication is connected, the signals of the trailer sensor arrangement are passed on to the control device instead of the signals of the rear sensor arrangement.

17. The device as claimed in claim 14, wherein the trailer is equipped with a trailer loudspeaker arrangement including a plurality of loudspeakers which are distributed along the circumference of the trailer, connected via the trailer power line communication to the control device and integrated into the signal transmitter system.

18. The device as claimed in claim 12, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

19. The device as claimed in claim 13, wherein the trailer is a semitrailer or a tow bar trailer.

20. The device as claimed in claim 13, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

21. The device as claimed in claim 14, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

22. The device as claimed in claim 15, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

23. The device as claimed in claim 17, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

24. The device as claimed in claim 15, wherein the trailer is equipped with a trailer loudspeaker arrangement including a plurality of loudspeakers which are distributed along the circumference of the trailer, are connected via the trailer power line communication to the control device and are integrated into the signal transmitter system.

25. A device for predictively detecting and avoiding motor vehicle collisions, comprising:
a control device;
a sensor system configured to sense obstacles in the surroundings of the vehicle;
a signal transmitter system configured to provide at least one of audible and visual signaling of a significant risk of collision between the vehicle and a first obstacle, wherein:
the vehicle is a utility vehicle,
the sensor system is divided into a front sensor arrangement which is arranged at the front of the vehicle, and a rear sensor arrangement which is arranged at the rear of the vehicle,
the front sensor arrangement is connected to the control device via a data bus,
the rear sensor arrangement is connected to the control device via a power line communication,
the signal transmitter system has an external loudspeaker arrangement including a plurality of loudspeakers which are distributed along the circumference of the vehicle, and
the control device actuates, as a function of the position of the first obstacle detected by the sensor system which is at risk of collision, the loudspeaker arrangement to output an audible warning signal in the direction of the first obstacle.

26. The device as claimed in claim 25, wherein:
the signal transmitter system has an internal loudspeaker arrangement including a plurality of loudspeakers which are distributed in a driver's cab along the circumference thereof, and
the control device actuates, as a function of the position of the first obstacle which is at risk of collision, the loudspeaker arrangement to output an audible warning signal from the direction of the first obstacle toward the driver.

27. The device as claimed in claim 25, wherein the trailer is equipped with a trailer loudspeaker arrangement including a plurality of loudspeakers which are distributed along the circumference of the trailer, are connected via the trailer power line communication to the control device and are integrated into the signal transmitter system.

28. A method for predictively detecting and avoiding motor vehicle collisions, comprising:
sensing obstacles in the surroundings of the vehicle via a sensor system;
determining in a control device a future direction of movement of the vehicle by evaluating at least one of a steering wheel lock angle, a flashing indicator light which has been set and a gear speed selector lever;
detecting a significant risk of collision based upon an instantaneous direction of movement of the vehicle or, if the vehicle is stationary, based upon the future direction of movement of the vehicle; and
signaling the significant risk of collision between the vehicle and a first obstacle via at least one of audible and visual signal via a signal transmitter system, wherein:
the sensor system is divided into a front sensor arrangement which is arranged at the front of the vehicle, and a rear sensor arrangement which is arranged at the rear of the vehicle,
the front sensor arrangement is connected to the control device via a data bus, and
the rear sensor arrangement is connected to the control device via a power line communication.

29. The method of claim 28, wherein:
the vehicle is a vehicle combination including a towing vehicle and a trailer, and
the rear of the vehicle is formed by the rear of the trailer.

30. The method of claim 28, wherein:
the sensor system includes a trailer sensor arrangement which is arranged in the region of the rear of the trailer,
the rear sensor arrangement of the towing vehicle is connected to the control device via a towing vehicle power line communication,
the trailer sensor arrangement is connected to the control device via a trailer power line communication, and
the towing vehicle power line communication and trailer power line communication are connected such that, when the trailer power line communication is connected, the signals of the trailer sensor arrangement are passed on to the control device instead of the signals of the rear sensor arrangement.

31. The method of claim 30, wherein:
the trailer sensor arrangement is connected via a trailer transceiver to at least one trailer power supply line of the towing vehicle and via which the trailer power line communication is provided, and
the control device transceiver is configured such that when the trailer power line communication is connected, the control device transceiver passes on the signals of the trailer sensor arrangement, instead of the signals of the rear sensor arrangement, to the control device.
